(19) United States
(12) Patent Application Publication
(10) Pub. No.: US 2026/0104090 A1
(43) Pub. Date: Apr. 16, 2026

(54) AXIALLY LOADED CROWN GEARING SYSTEM INCLUDING SNAP-ON SEALING RING

(71) Applicant: Volkswagen Aktiengesellschaft, Wolfsburg (DE)

(72) Inventors: Gregor SCHAAF, Wolfsburg (DE); Jan-Eric KUHNT, Wolfsburg (DE)

(21) Appl. No.: 19/327,971

(22) Filed: Sep. 12, 2025

(30) Foreign Application Priority Data
Sep. 20, 2024 (DE) 102024209038.7

(51) Int. Cl. F16J 15/02; B60B 27/00

(52) U.S. Cl. CPC F16J 15/025; B60B 27/0073

(57) ABSTRACT

An axially loaded crown gearing system includes a first component with a first crown gear and a second component with a second crown gear in toothing engagement and axially clamped to provide zero-backlash transmission. A snap-on sealing ring surrounds the gears radially, is fixed to one component, and has at least one catch lug that detents in a recess of the other component to establish a pre-assembly condition and preclude tooth-on-tooth assembly. The ring has an end-face circumferential sealing surface that, in the clamped condition, provides axial sealing either (i) against an elastic sealing element that is axially less rigid than the ring or (ii) against a sealing element formed as an axially extending extension of a wheel-bearing seal. The arrangement enables reliable sealing and tolerance compensation while simplifying assembly and protecting the toothing engagement from contamination and corrosion.

### RELATED APPLICATIONS

The present application claims priority to German Patent App. No. DE 10 2024 209 038.7, filed Sep. 20, 2024, the contents of which is incorporated by reference in its entirety herein.

### TECHNICAL FIELD

The present disclosure relates to axially loaded crown gearing (Hirth/face gearing) systems and associated sealing and tolerance-compensation arrangements for zero-backlash torque transmission, including configurations employing snap-on sealing rings that cooperate with elastic sealing elements or with axially extending extensions of wheel-bearing seals.

### BACKGROUND

Axially loaded crown gearing systems-also referred to as Hirth joint or face gearing systems—are used as connections for zero-backlash torque transmission in vehicle construction, for example between a drive joint shaft and a wheel hub. Especially when transmitting high torque, such as in motor vehicles with an electric drive, axially loaded crown gearing systems can offer advantages over conventional spline systems because torque can be reliably transmitted under high, changing torques without relative movements (which can result from the torsional elasticity of splines) and without interfering “ping” noise.

To ensure torque transmission, the crown gearing system is clamped using a high axial force. The two crown gears, which are subject to high material stresses and are in engagement with one another, are to be appropriately protected against corrosion. In addition, during assembly the corresponding crown gears are to be brought into correct mesh with one another to prevent tooth-on-tooth assembly.

DE 10 2007 057 047 A1 describes an axially loaded crown gearing system in which a clamping device in the form of a connecting screw is supported by a spring element. The possible spring travel between a tooth-on-tooth position and a tooth-in-gap position is not appreciably less than the height of the crown gear teeth. The spring element can be an elastomer sleeve and/or a helical spring. In an assembly process of a wheel hub component with a universal joint component connected by way of a crown gearing system, the connecting bolt may first be tightened with very little torque so as to establish a tooth-in-gap position—in the event of an initial tooth-on-tooth position—either by applying torque or under the action of the spring element. After a temporal interruption, the components can then be clamped together by tightening the bolt connection with a higher torque. Installing the spring element adds assembly complexity; the spring element remains in the system although it is only needed during assembly, which increases weight and necessitates additional installation space.

DE 10 2005 018 126 A1 describes another axially loaded crown gearing system in which the above-described spring element is eliminated. Preventing a tooth-on-tooth position during loading can be difficult because the two crown gears to be paired are to be aligned while the clamping device is simultaneously fed and screwed on with proper alignment. In other words, the constant-velocity joint of a cardan shaft is to be held in position with respect to a wheel hub at the same time a connecting bolt is attached. This can be performed by assembly staff or in an automated manner. Due to this temporal coupling, it may be advisable to position the components to be joined and to bolt them together in the same assembly cycle, which is relatively complex because three components are handled simultaneously.

With respect to sealing, DE 10 2005 018 126 A1 proposes a simple plastic sealing ring or, alternatively, sealing pastes to inhibit moisture and dirt from penetrating from the outside into the joint of the paired crown gears.

DE 10 2012 207 054 A1 proposes a rubber-metal seal that radially surrounds the crown gears in engagement. In that arrangement, the bearing surface of a rubber lip on a journal is to be coated, which is associated with additional effort and cost. During assembly, the rubber lip is to be protected against damage; prior to installation, a transport guard in the form of a cover can be used at the wheel bearing.

DE 10 2008 050 127 A1 describes a crown gearing system having a snap-on sealing ring that includes, on its inner side, a catch lug and a sealing lip that is pushed over a shaft section on the radially inner side. An axial seal is not provided. Moisture can penetrate into a gap between the snap-on sealing ring and the wheel hub and accumulate at the sealing lip. Because the sealing lip bears against a metallic component, corrosion may occur beneath this contact region over time absent additional protective measures such as a coating.

WO 2022/157283 A1 describes another crown gearing system comprising a sealing lip that is pushed onto a shaft section; in that case, the seal does not provide a retaining clip.

A further axially loaded crown gearing system including a snap-on sealing ring is described in post-published DE 10 2023 202 581 A1, in which the snap-on sealing ring can serve as an assembly aid for maintaining tooth engagement and can act as a seal after axial loading of the crown gearing system.

Cost-effective component manufacturing is associated with larger manufacturing tolerances. In such cases, the axial position of sealing surfaces can vary by approximately ±0.5 mm with respect to one another. Compensating by more precise manufacturing can be disproportionately expensive. While this particular tolerance-related issue does not arise in the arrangement of DE 10 2008 050 127 A1, that configuration presents a gap space in which moisture may accumulate.

### SUMMARY

Some aspects of the present disclosure provide improved sealing for an axially loaded crown gearing system while preserving cost-effective manufacturing.

In one aspect, an axially loaded crown gearing system includes a first component with a first crown gear and a second component with a second crown gear, the first and second crown gears being in toothing engagement and axially loaded with respect to one another. A snap-on sealing ring surrounds the crown gears radially on the outside and is fixed to one of the components. The snap-on sealing ring has, axially at its end face, a circumferential sealing surface configured to provide sealing with respect to an elastic sealing element that is axially less rigid than the snap-on sealing ring when an axially zero-backlash assembly position of the first and second crown gears has been reached.

In another aspect, an axially loaded crown gearing system includes a snap-on sealing ring that surrounds the crown gears radially on the outside and is fixed to one of the components. The snap-on sealing ring has, axially at its end face, a circumferential sealing surface configured to provide sealing with respect to a sealing element formed as an axially extending extension of a wheel bearing seal when an axially zero-backlash assembly position of the first and second crown gears has been reached.

Compared to arrangements such as DE 10 2005 018 126 A1, the assembly steps can be decoupled—namely, aligning the components to ensure that tooth-on-tooth assembly is precluded and, separately, clamping—so handling remains simple. Moreover, due to the configuration of the snap-on sealing ring, an additional spring element as in DE 10 2007 057 047 A1 can be dispensed with.

The snap-on sealing ring is configured to provide a sealing function that inhibits penetration of moisture and dirt, so no additional measures are required in this regard. In particular, the need for a complex rubber-metal seal and/or for coating components is eliminated, and a transport guard as described in connection with DE 10 2012 207 054 A1 can be omitted.

The snap-on sealing ring also allows tolerance compensation, enabling cost-effective production of structures required for axial sealing.

### BRIEF DESCRIPTION OF THE DRAWINGS

Aspects of the present disclosure are described in greater detail based on examples illustrated in the drawings. In the drawings:

FIG. 1 illustrates a longitudinal sectional view of an axially loaded crown gearing system, according to some aspects of the present disclosure;

FIG. 2 illustrates a schematic representation of a further example showing a pre-assembly position (left) and a final assembly position (right) of components to be joined to one another, including an axially loaded crown gearing system, according to some aspects of the present disclosure;

FIG. 3 illustrates a detailed view of a first variant example of an elastic sealing element, according to some aspects of the present disclosure;

FIG. 4 illustrates a detailed view of a second variant example of an elastic sealing element, according to some aspects of the present disclosure;

FIG. 5 illustrates a detailed view of a third variant example of an elastic sealing element, according to some aspects of the present disclosure;

FIG. 6 illustrates a detailed view of a fourth variant example of an elastic sealing element, according to some aspects of the present disclosure;

FIG. 7 illustrates a detailed view of a fifth variant example of an elastic sealing element, according to some aspects of the present disclosure;

FIG. 8 illustrates a detailed view of a sixth variant example of an elastic sealing element, according to some aspects of the present disclosure;

FIG. 9 illustrates a detailed view of a seventh variant example of an elastic sealing element, according to some aspects of the present disclosure;

FIG. 10 illustrates an axial view of a first variant example of a ring, according to some aspects of the present disclosure;

FIG. 11 illustrates a schematic representation of a further example for sealing an axially loaded crown gearing system, according to some aspects of the present disclosure;

FIG. 12 illustrates an axial view of a variant example of a snap-on sealing ring, according to some aspects of the present disclosure;

FIG. 13A through FIG. 13F illustrate a representation showing tolerance compensation with a tooth-on-tooth position (top) and correct toothing engagement (bottom), according to some aspects of the present disclosure;

FIG. 14 illustrates a schematic representation of a further example for sealing an axially loaded crown gearing system, according to some aspects of the present disclosure.

### DETAILED DESCRIPTION

In some examples, a soft, elastic sealing element is used to compensate for potential manufacturing tolerances when clamping the crown gearing system. The force applied to compress the elastic sealing element during preload is negligible relative to the preload force of the crown gearing system. Because the elastic sealing element is axially less rigid than the snap-on sealing ring, the required axial tolerance compensation is taken up predominantly by the elastic sealing element, while the snap-on sealing ring can be configured with higher rigidity, in particular to reliably perform as an assembly aid.

A softer seal further promotes effective sealing performance. Because sealing occurs axially at the end face on the snap-on sealing ring, the formation of a gap in which moisture could accumulate is inhibited.

Additional examples and configurations are described herein.

In some examples, the snap-on sealing ring and the elastic sealing element are configured in terms of their rigidity to axially compensate a dimensional tolerance between the first and second components and the snap-on sealing ring of 1 to 2 mm while maintaining the seal. This allows the relevant axial sealing surfaces to be manufactured cost-effectively because dimensional deviations are predominantly absorbed by the elastic sealing element.

In some examples, the elastic sealing element comprises an elastomer having a Shore A hardness of 20 to 60, and in further examples 35 to 50. A soft rubber can be used for this purpose.

In some examples, the elastic sealing element is integrally formed on a sealing element of a wheel bearing seal 60 (which may be implemented as a radial bearing seal) to reduce parts variety and assembly complexity.

Radial bearing seals often employ acrylonitrile-butadiene rubber (NBR). When used with an encoder, such NBR may be too rigid for flexible axial tolerance compensation. Conventional NBRs are comparatively hard and inflexible: although they readily withstand compressive loads, they are less suited to bending and tensile loads.

As a remedial measure, the integrally formed elastic sealing element can be manufactured from a different material than the sealing element of the wheel bearing seal, with the elastic sealing element preferably having a lower Shore A hardness than the sealing element of the wheel bearing seal. This yields a one-piece component that addresses both wheel-bearing-seal requirements and the desired tolerance compensation.

In some examples, the elastic sealing element includes two legs joined to and angled with respect to one another, both of which, in the loaded state, bear against the snap-on sealing ring. Two sealing points are thereby created, improving sealing performance.

When the legs are integrally formed on a sealing element of the wheel bearing seal, the connection can be hinge-like so as to achieve favorable double contact with an end section of the snap-on sealing ring.

In some examples, the elastic sealing element is configured as a sealing plate with a sealing lip having at least one circumferential trough, and the snap-on sealing ring is pushed with its axial end into the trough. Such a shape facilitates compensation over a comparatively large tolerance range.

In this connection, the circumferential sealing surface at the axial end of the snap-on sealing ring can include a rounded region adapted to the contour of the trough. This mutual form-lock favors targeted deformation of the elastic sealing element at a defined location.

In some examples, the elastic sealing element is configured as a sealing plate with a sealing lip having an omega-shaped cross-section, and the snap-on sealing ring is pushed with its axial end against an apex of the omega shape. The omega shape can provide a relatively large axial contact surface for the snap-on sealing ring, promoting reliable sealing when the crown gearing system is clamped.

In some examples, the elastic sealing element comprises a ring section configured to axially bear against the other component, from which one or more circumferential sealing lips protrude toward the snap-on sealing ring and are urged into sealing contact with the ring. In cross-section, the one or more circumferential sealing lips form a positive or negative angle, having a magnitude in the range of 20° to 70°, with the ring section in the region where the sealing lips bear against the snap-on sealing ring.

The axially loaded crown gearing systems disclosed herein are particularly suited for use where an elastic sealing element of a wheel bearing seal having a relatively high Shore A hardness must be used. In such cases, tolerance compensation can occur by elastic widening of the snap-on sealing ring in the engagement region and/or by deformation of an axially extending extension. The snap-on sealing ring can thus be pushed axially farther onto the axially extending extension to compensate for dimensional deviations.

An additional sealing gap can be avoided by integrating the sealing arrangement into the wheel bearing seal.

In some examples, the axially extending extension has a cone angle in a range of 5° to 50°, and in further examples in a range of 5° to 25°. In this manner, the snap-on sealing ring can be pushed with its circumferential sealing surface onto the sealing element with relative ease.

To bias the seal predominantly to compression loads, a bearing surface at the wheel-bearing inner ring can be configured as a support surface 24, preferably conical. The cone angle of the seal can be slightly smaller (flatter) than the cone angle of the underlying support surface 24 to facilitate assembly. A cylindrical seal used with a conical support surface 24 is also possible. It is furthermore advantageous when the circumferential sealing surface 46, for bearing against the axially extending extension 62, has a cone angle that is smaller than the cone angle of a conical sliding surface 41b at the catch lug 41a, and is located radially further to the outside than the conical sliding surface 41b of the catch lug 41a. This functional separation makes a configuration possible that is favorable for the particular engagement, namely good sealing action on the one hand and overcoming the detent protrusion 22 by the catch lug 41a with a short displacement distance on the other hand. In addition, it is avoided that the sealing surface 46 is impaired by the detent protrusion 22 being overcome.

In some examples, the snap-on sealing ring is radially less rigid than the axially extending extension, and the snap-on sealing ring widens elastically in the radial direction when the crown gearing system is axially loaded.

The snap-on sealing ring is generally formed of a plastic material, providing corrosion-free contact with the elastic sealing element and enabling cost-effective manufacture.

As described herein, in the unloaded state of the crown gearing system the snap-on sealing ring can act as a retaining clip that holds the first and second crown gears loosely in engagement such that an axial play is smaller than the tooth height of the first and second crown gears.

The snap-on sealing ring can form multiple catch lugs distributed around its circumference that, after overcoming a protrusion on the other component, engage in one or more recesses of the other component. During passage over the protrusion, the snap-on sealing ring temporarily expands elastically and then springs back. The number of catch lugs can be selected as needed, for example in a range of 3 to 20.

In the non-loaded state of the crown gearing system, the catch lugs are accommodated with axial play in the corresponding recess or recesses. From this pre-assembled state, the crown gearing system can then be axially loaded. The snap-on sealing ring, including the catch lugs, can be designed for pre-assembly such that the dead weight of the components to be joined and the forces applied during actuation of the clamping device are accommodated without the pre-assembled state becoming undone.

Based on the detent engagement, a correct connection can be verified during assembly; in particular, it can be confirmed that an undesirable tooth-on-tooth position is not present.

In some examples, the snap-on sealing ring is fixed to one of the first and second components and is coupled to the other by a detent mechanism. This allows the snap-on sealing ring to be pre-assembled on one of the components to be joined; for example, the ring can be press-fit, bonded, or otherwise attached.

In particular, the snap-on sealing ring can include a section that forms the catch lugs, wherein this section is radially elastically compressible and extendable to readily overcome a detent resistance. This configuration also favors pushing the snap-on sealing ring onto the axially extending extension.

The snap-on sealing ring can be matched to the crown gears to be paired such that, after the protrusion has been overcome by a catch lug, the overlap of the teeth of the first and second crown gears is 30% to 90% of their tooth height. In this way, a tooth-on-tooth position can be reliably precluded after pre-assembly.

The circumferential sealing surface on the snap-on sealing ring can be perpendicular to the axial direction, oblique to the axial direction, curved, or a combination of such surface geometries.

The axially loaded crown gearing systems disclosed herein are well-suited to connect a constant-velocity joint to a wheel hub including a wheel bearing, without limiting the present disclosure. In such an arrangement, the first component is a constant-velocity joint, the second component is a wheel hub with a wheel bearing, and a clamp bolt centrally guided through the first and second crown gears clamps the components together. Such a connection can reliably transmit high, changing torque with compact outside dimensions, while reducing interfering noise and potential relative movements at the connection.

In some examples, the snap-on sealing ring latchingly engages and seals against an inner ring of the wheel bearing, which is mounted on the wheel hub; herein, the inner ring is understood as a component separate from the wheel hub.

In another example, the snap-on sealing ring latchingly engages a section of the wheel hub itself, independent of whether a dedicated inner ring is provided for the wheel bearing.

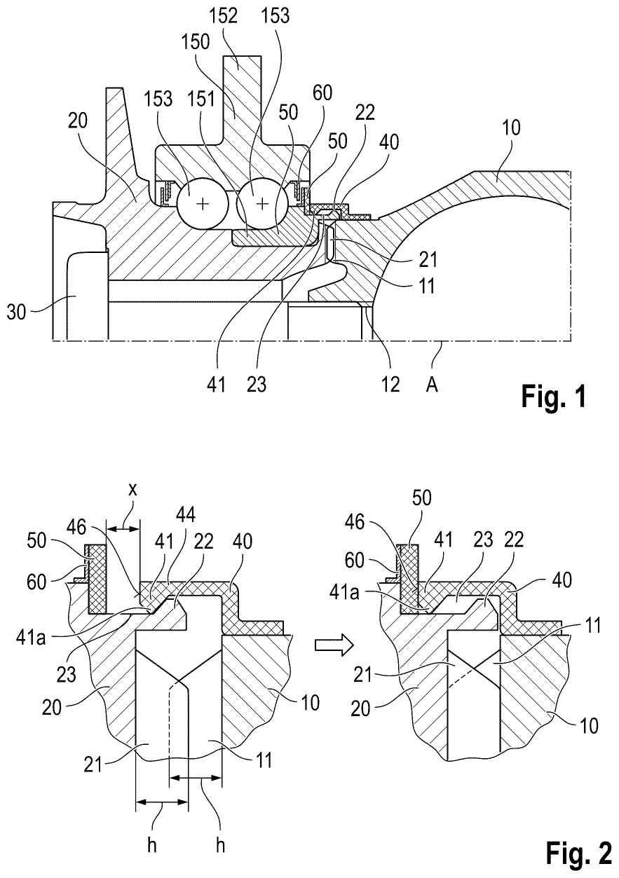

FIG. 1 illustrates an axially loaded crown gearing system in a clamped, final assembly position.

The axially loaded crown gearing system includes a first component 10 having a first crown gear 11 and a second component 20 having a second crown gear 21.

As used herein, a “crown gear” refers to an end-face radial gearing structure on a component that can be coupled with a corresponding end-face radial gearing structure on another component for torque transmission.

By way of example, the first component 10 can be a constant-velocity joint 110 of a cardan (propeller) shaft, without limitation.

By way of example, the second component 20 can be a wheel hub including a wheel bearing, without limitation.

The first crown gear 11 and the second crown gear 21 are in toothing engagement. In FIG. 1 the engagement is zero-backlash and suitable for transmitting high torque.

A clamping device 30 is provided—in some examples a clamp bolt—by which, when clamped, the first crown gear 11 and the second crown gear 21 are axially loaded with respect to one another.

The clamping device 30 preferably extends centrally through the crown gears 11, 21. In some examples, the clamping device 30 (e.g., the clamp bolt) is supported on the second component 20 and bolted to the first component 10; a reverse arrangement is also possible.

The system further includes a snap-on sealing ring 40 that surrounds the first crown gear 11 and the second crown gear 21 radially on the outside and provides sealing.

In the unclamped state of the clamping device 30, the snap-on sealing ring 40 can act as a retaining clip by which the first crown gear 11 and the second crown gear 21 are held loosely in engagement during assembly, forming a pre-assembly position in which the first component 10 and the second component 20 are roughly aligned.

As shown schematically in FIG. 2 (left), in the pre-assembly position an axial play x between the crown gears 11, 21 is smaller than the tooth height h of the crown gears 11, 21. Once the pre-assembly position has been reached, a tooth-on-tooth position is thereby precluded.

In a subsequent step, after the pre-assembly position has been established, the clamping device 30 is tightened to establish zero-backlash engagement of the crown gears 11, 21 and to reach the final assembly position (see FIG. 2, right; see also FIG. 1).

In the final assembly position, penetration of moisture and dirt from the outside into the joint between the crown gears 11, 21 is suppressed by the snap-on sealing ring 40, protecting the toothing engagement against corrosion. Coating of relevant shaft sections beneath the snap-on sealing ring 40 can therefore be omitted.

The arrangement of the snap-on sealing ring 40 relative to the first component 10 and the second component 20, as well as the configuration of the ring, can be implemented in a variety of ways. Engagement structures with respect to the first component 10 and the second component 20 can also be interchanged.

In the examples shown in FIGS. 1 and 2, the snap-on sealing ring 40 is fixed to one of the components 10, 20 and coupled to the other by a detent mechanism 41. Based on the snap-fit engagement, reaching the pre-assembly position can be verified, i.e., a tooth-on-tooth position is precluded.

The snap-on sealing ring 40 can be fixed to either the first component 10 or the second component 20 (to the first component 10 in the example shown) by press-fitting, adhesive bonding, or another attachment. In some examples, this fixing is performed before the components 10, 20 are brought together to achieve the pre-assembly position.

For the detent mechanism 41, one or more catch lugs 41a can be formed on the ring 40, optionally distributed around its circumference, which—after overcoming a protrusion 22 on the other component (the second component 20 in the example shown)—engage in one or more recesses 23 of that component.

An axial view of a snap-on sealing ring 40 is shown in FIG. 12. In the illustrated example, the ring 40 includes three catch lugs 41a on its inner circumferential surface 42. Other numbers are possible, for example in a range of about 3 to 20.

Correspondingly, the protrusion 22 and the recess 23 are located on an outer circumferential section of the second component 20. The protrusion 22 and the recess 23 can be provided as continuous circumferential features so the angular position of the ring 40 in the circumferential direction is immaterial during assembly; alternatively, multiple individual protrusions and/or multiple individual recesses can be used.

In a modification of the illustrated specific embodiments, the catch lugs 41a, however, can also be arranged on an outer circumferential surface 43 of the snap-on sealing ring 40, instead of on the inner circumferential surface 42. Accordingly, the protrusion 22 and the recess 23 of the second component 20 are then located on an inner circumferential section of the same.

As described herein, in the unclamped state of the clamping device 30 the one or more catch lugs 41a are accommodated with axial play in the corresponding recess or recesses 23. When the protrusion 22 is overcome by the catch lugs 41a, the overlap of the teeth of the first crown gear 11 and the second crown gear 21 can be in a range of 30% to 90% of the tooth height.

To facilitate assembly—particularly when using a detent mechanism 41 that includes catch lugs 41a—the snap-on sealing ring 40 can include a section 44 on which the catch lugs 41a are formed, the section 44 being radially elastically compressible and extendable (e.g., by at least one slit 45) to more easily overcome the detent resistance presented by the protrusion 22.

Chamfers or sliding surfaces 41b provided on the catch lugs 41a and/or on the protrusion 22 can further support this detenting action.

The ring 40 includes a circumferential sealing surface 46 that, in the loaded state of the crown gearing system—i.e., when an axially zero-backlash assembly position of the first and second crown gears 11, 21 has been reached—provides sealing with respect to an elastic sealing element 50 that is axially less rigid than the snap-on sealing ring 40.

As shown by way of example in FIGS. 1 and 2, the circumferential sealing surface 46 of the snap-on sealing ring 40 is formed by an end-face wall section. The circumferential sealing surface 46 can be a surface perpendicular to the axial direction A, a surface oblique to the axial direction A, a curved surface, or a combination of such surfaces that adjoin one another.

As described herein, the elastic sealing element 50 is axially more compliant than the snap-on sealing ring 40. The compliance can arise from material compressibility of the elastic sealing element 50 and/or from structural flexibility (e.g., bending) of the element 50, and both effects can be combined.

A soft elastic sealing element 50 enables compensation of potential manufacturing tolerances when the crown gearing system is loaded and, in association therewith, when axial sealing is created between the snap-on sealing ring 40 and the elastic sealing element 50.

Because the elastic sealing element 50 is axially less rigid than the snap-on sealing ring 40, the required elastic compensation for tolerance take-up is provided predominantly by the elastic sealing element 50, while the snap-on sealing ring 40 can be configured with greater axial rigidity, in particular to reliably function as an assembly aid.

The soft elastic sealing element 50 further promotes high sealing performance. Because sealing occurs axially at the end face of the snap-on sealing ring 40, formation of a gap beneath the snap-on sealing ring 40 in which moisture could accumulate is inhibited. Sealing is preferably achieved via non-metallic contact surfaces, and a coating beneath the snap-on sealing ring 40 is not necessary.

The snap-on sealing ring 40 and the elastic sealing element 50 can be configured in terms of axial rigidity to compensate a dimensional tolerance between relevant sealing surfaces of 1 to 2 mm while maintaining sealing performance. This permits cost-effective manufacture of axial sealing surfaces because dimensional deviations are predominantly absorbed by the elastic sealing element 50.

In some examples, the elastic sealing element 50 comprises an elastomer having a Shore A hardness of 20 to 60, and in further examples 35 to 50; a soft rubber can be used.

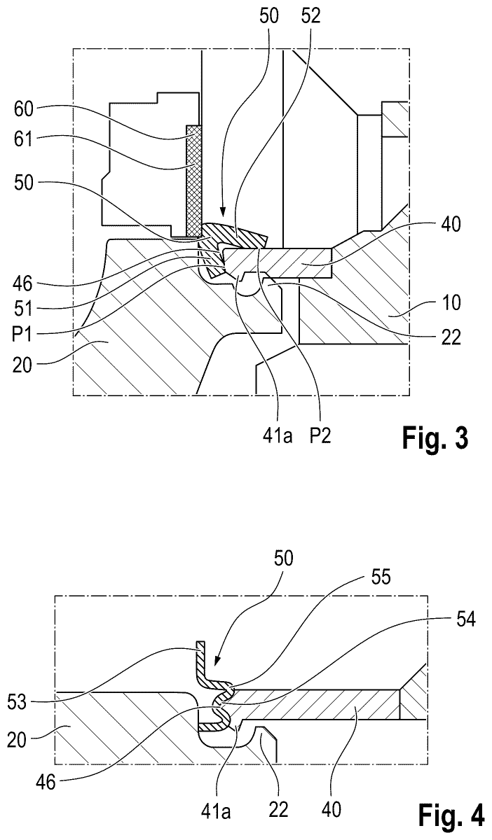

With reference to FIGS. 3 to 9, various examples of the elastic sealing element 50 are described herein, without limiting the present disclosure to the specific examples shown.

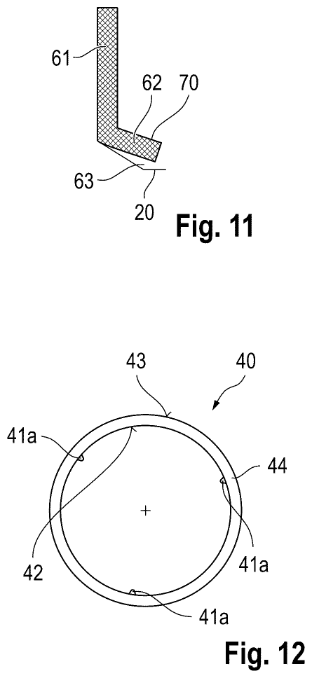

In some examples, the elastic sealing element 50 is provided as a separate component to be handled during assembly. In other examples (see FIG. 11), the elastic sealing element 50 is integrally formed on a sealing element 61 of a wheel bearing seal 60, reducing parts variety and assembly complexity.

The elastic sealing element 50 can be made of the same material as the sealing element 61 of the wheel bearing seal 60; however, in some examples a lower Shore A hardness is used for the elastic sealing element 50 because elastomers commonly used for sealing elements 61 of wheel bearing seals 60 (e.g., acrylonitrile-butadiene rubber with Shore A>70) can be too rigid for the tolerance compensation desired herein for reliable axial sealing.

FIG. 3 illustrates a first variant example of the elastic sealing element 50. In cross-section, the element 50 is rotationally symmetrical and includes two legs 51, 52 joined to and angled with respect to one another; in the clamped state, both legs bear against the snap-on sealing ring 40, creating two separate sealing points P1 and P2 and providing high sealing performance.

In the unclamped state, the two legs 51, 52 are arranged approximately V-shaped with respect to one another (indicated by a dotted line in FIG. 3), the V opening toward the snap-on sealing ring 40.

As the snap-on sealing ring 40 is pushed between the legs 51, 52 during loading of the crown gearing system, the circumferential sealing surface 46 bears against the first leg 51 to effect axial sealing, while the second leg 52 bears radially on an outer wall section of the snap-on sealing ring 40 to provide additional sealing.

The V shape can pivot slightly during clamping, as illustrated in FIG. 3 by the transition from the dotted outline to the solid outline of component 50.

As shown by way of example in FIG. 3, the legs 51, 52 can be integrally formed on the sealing element 61 of the wheel bearing seal 60, with the legs 51, 52 having a lower Shore A hardness than the sealing element 61. The sealing element 61 can be formed of acrylonitrile-butadiene rubber.

The legs 51, 52 are preferably connected to the wheel bearing seal 60 in a hinge-like manner so that, due to their mobility, favorable double contact with the axial end section of the snap-on sealing ring 40 is achieved; elastic bending of the legs 51, 52 promotes effective sealing.

The snap-on sealing ring 40 is made of a plastic at least in the region of sealing points P1 and P2 so that the non-metallic contact reduces the risk of corrosion propagating beneath the seal.

FIG. 4 illustrates a second variant example in which the elastic sealing element 50 is configured as a sealing plate 53 with a sealing lip 55 that includes at least one circumferential trough 54; the snap-on sealing ring 40 is pushed with its axial end—namely, its circumferential sealing surface 46—into the trough 54, allowing a comparatively large axial tolerance range to be readily compensated.

In some examples, the axial end of the snap-on sealing ring 40 (i.e., the circumferential sealing surface 46) includes a rounded region adapted to the contour of the trough 54; this mutual form-lock promotes targeted bending of the elastic sealing element 50 at a defined location and provides a large contact region at the sealing point.

The sealing plate 53 can be integrally formed on a harder sealing element 61 of a wheel bearing seal 60.

In some examples, the sealing plate 53 is implemented as a diaphragm with a substantially constant wall thickness and, in cross-section (see FIG. 4), has the shape of a “lying M” to provide the circumferential trough 54.

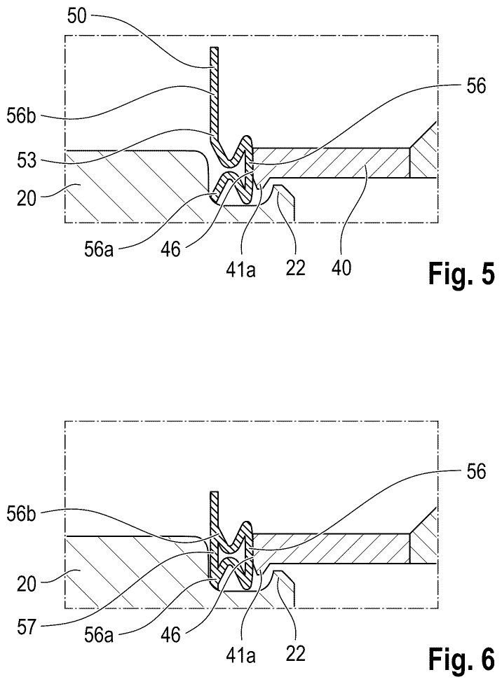

FIGS. 5 and 6 illustrate third and fourth variant examples of the elastic sealing element 50.

In FIG. 5, the elastic sealing element 50 is again configured as a sealing plate 53 having a sealing lip 56 with an omega-shaped cross-section, wherein the snap-on sealing ring 40 is pushed with its axial end against an apex of the omega shape; the desired axial tolerance compensation is provided by the combination of this geometry and the soft elastomeric material, and the sealing lip 56 bends readily under contact with the sealing surface 46, offering greater elasticity than a solid buffer.

The omega shape provides a relatively large axial bearing surface for the snap-on sealing ring 40, so the sealing function is achieved with high reliability when the crown gearing system is clamped.

In FIG. 5, the free legs 56a and 56b at the ends of the omega shape can be obliquely angled relative to the axial direction to create an additional elastic spring effect against the second component 20.

In some examples, one free leg 56b is connected to the elastic sealing element 61 of the wheel bearing seal 60, while the other free leg 56a is supported on a wall section of the second component 20.

In the modification shown in FIG. 6, the free legs 56a and 56b of FIG. 5 are additionally connected by a ring section 57, which can in turn be connected to the elastic sealing element 61 of the wheel bearing seal 60; this yields a ring with a closed cross-section that encloses a cavity within the elastic sealing element 50, the cavity optionally including a ventilation opening.

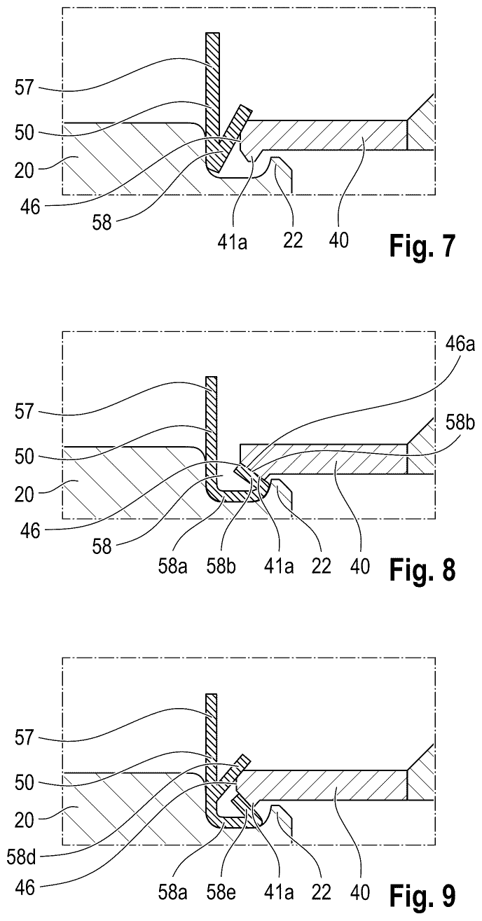

In the further variant examples of FIGS. 7 to 9, the elastic sealing element 50 initially includes a ring section 57 configured to axially bear against the other component 20; optionally, the ring section 57 can also provide a connection to the elastic sealing element 61 of the wheel bearing seal 60.

One or more circumferential sealing lips 58 protrude from the ring section 57 toward the snap-on sealing ring 40 and are urged into sealing contact with the ring 40; in cross-section, the one or more sealing lips 58 form a mathematically positive or negative angle of 20° to 70° with the ring section 57 at the region of contact with the snap-on sealing ring 40, as shown by way of example in FIGS. 7 to 9.

In FIG. 7, exactly one circumferential sealing lip 58 is provided; it extends from a radially inner end of the ring section 57 obliquely outward to bear against the sealing surface 46 of the snap-on sealing ring 40, yielding an approximate V-shape in cross-section; the branching location of the sealing lip 58 from the ring section 57 can alternatively be positioned further radially outward.

FIG. 8 shows a sealing lip 58 having a bent cross-sectional profile and including a first section 58a that protrudes axially from the ring section 57 and transitions into a bent second section 58b that points back toward the ring section 57, thereby providing an oblique bearing surface 58c for a conical surface section 46a or a chamfer of the circumferential sealing surface 46 of the snap-on sealing ring 40.

As shown in FIG. 9, multiple sealing lips 58 can be provided on the ring section 57 so that, similar to FIG. 3, multiple sealing points P1 and P2 are formed on the snap-on sealing ring 40.

For example, a first sealing lip 58d can correspond approximately to the sealing lip of FIG. 7 but shifted radially outward; due to its inclination, the first sealing lip 58d provides an outer first sealing point P1 with the sealing surface 46 of the snap-on sealing ring 40; a second sealing lip 58e can be configured similar to FIG. 8 and provide a second sealing point with the sealing surface 46.

Optionally, the inclination of the sealing surface 46 of the snap-on sealing ring 40 can be adapted to the respective sealing lips 58d and 58e.

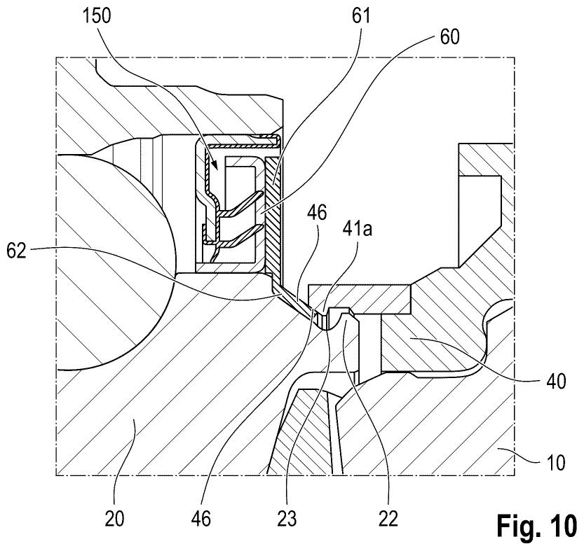

FIGS. 10 and 11 illustrate a second exemplary embodiment with a modified seal.

The snap-on sealing ring 40 can be configured as described herein; in particular, it includes an end-face circumferential sealing surface 46 that provides sealing with respect to a sealing element 70 when an axially zero-backlash assembly position of the first and second crown gears 11, 21 has been reached.

The sealing element 70 is formed as a circumferential, axially extending extension 62 of a wheel bearing seal 60—particularly of its elastic sealing element 61—and protrudes from the functional region of the wheel bearing seal 60.

The axially extending extension 62 can have a substantially constant wall thickness.

The extension 62 can extend from the wheel bearing seal 60 obliquely radially inward and can, for example, be conical.

In some examples, the axially extending extension 62 has a cone angle α in a range of 5° to 50°, and preferably in a range of 5° to 25°.

It is also possible that only the snap-on sealing ring 40 is conical, or that an acrylonitrile-butadiene rubber (NBR) seal of the wheel bearing is formed without angles while a steel surface located beneath is conical; alternatively, all cooperating surfaces can be cylindrical and furnished with beveled ends.

As described herein, conventional materials used for elastic sealing elements 61 of a wheel bearing seal 60 can be too hard or too rigid for tolerance compensation of the magnitude discussed when deformation is to be achieved primarily by compression of the sealing material.

Due to a thin-walled configuration, structural elasticity can be realized such that the axially extending extension 62 yields slightly under load; likewise, the snap-on sealing ring 40 can widen elastically in the radial direction and be pushed farther axially onto the extension 62; the combination of these effects can be used for tolerance compensation, and their relative contributions can be adjusted as needed; in this manner, the extension 62 can be formed of a harder sealing material (e.g., an elastomer with Shore A≥70) and integrated into the sealing element 61 of the wheel bearing seal 60 using the same material, thereby avoiding additional sealing interfaces between functional regions; the snap-on sealing ring 40 can, for example, be formed of polyamide 6 (PA6) or materials with comparable properties.

In some variants, the snap-on sealing ring 40 is radially less rigid than the conical extension 62 such that, under axial loading of the crown gearing system, the snap-on sealing ring 40 widens more strongly in the engagement region with the axially extending extension 62.

In such cases, axial tolerance compensation occurs primarily through elastic widening of the snap-on sealing ring 40 in the engagement region; as a result, the snap-on sealing ring 40 is pushed farther axially onto the axially extending extension 62 to compensate dimensional deviations.

Predominant deformation for tolerance compensation is taken up by the snap-on sealing ring 40, with the axially extending extension 62 also deforming slightly; in the unloaded state, the conical extension 62 preferably does not bear directly against the component 20 but instead has a small movement space (air gap 63 in FIG. 11), which can slightly expand the axial tolerance range and cause contact with the snap-on sealing ring 40 to occur earlier during joining.

To bias the sealing interface predominantly to compression loads, a bearing surface at the second component 20 (e.g., a wheel-bearing inner ring) can be configured as a support surface, preferably conical; the cone angle of the seal can be slightly smaller (flatter) than the cone angle of the underlying support surface to facilitate assembly (see FIG. 11); a cylindrical seal combined with a conical support surface is also possible.

Because the snap-on sealing ring 40 is generally formed of a plastic material, corrosion-free contact is provided with respect to the sealing element 70.

In addition to axial sealing and tolerance compensation, the snap-on sealing ring 40 can function as an assembly aid for positioning components 10, 20 to avoid a tooth-on-tooth condition; joining to the pre-assembly position can occur in a first work cycle, and the clamping device 30 can then be applied and tightened in a second work cycle without requiring an additional holding fixture for the second component 20; the axial clamping force can be on the order of about 80 kN or greater.

In some variants, the retaining force of the snap-on sealing ring 40 is selected such that axial displacement to an end position occurs under the clamping force applied by the clamping device 30.

The clamping device 30 can be a clamp bolt guided centrally through the first crown gear 11 of the constant-velocity joint 110 and the second crown gear 21 at the wheel hub, thereby axially clamping the components.

In one example, a head of the clamp bolt is supported on the wheel hub, while a threaded section of the clamp bolt is received in a threaded opening 12 of the constant-velocity joint 110, for example in an axle journal; the reverse arrangement is also possible.

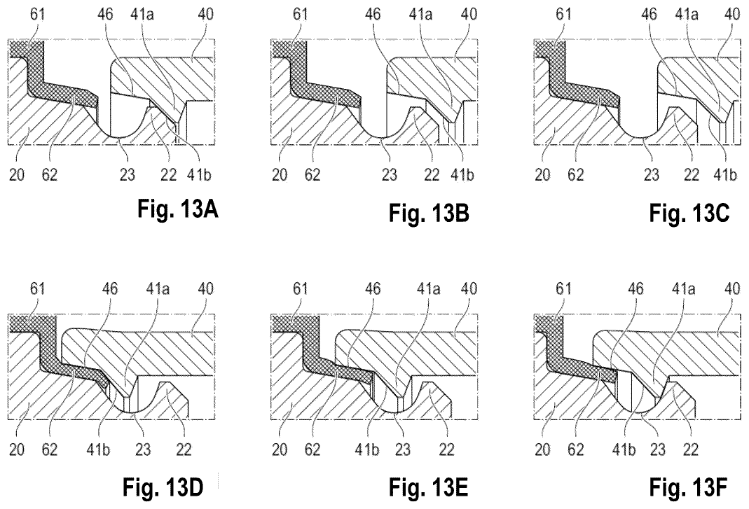

FIG. 13A through FIG. 13F illustrate a further modification of the snap-on sealing ring 40 in which a conical circumferential sealing surface 46 bears against the axially extending extension 62; the sealing surface 46 can have a cone angle in a range of 5° to 50°, and preferably 5° to 25°.

The conical circumferential sealing surface 46 is positioned axially upstream of the catch lug 41a; the catch lug 41a includes a conical sliding surface 41b facing the sealing surface 46 that is steeper than the conical circumferential sealing surface 46 and facilitates overcoming the protrusion 22 during detenting.

As shown in FIG. 13A through FIG. 13F, the cone angle of the conical circumferential sealing surface 46 is smaller than the cone angle of the conical sliding surface 41b at the catch lug 41a, and the conical circumferential sealing surface 46 is located radially farther outward than the conical sliding surface 41b; the steeper sliding surface 41b shortens the axial travel needed to pass the protrusion 22, supporting a compact design; optionally, the detent mechanism can be tuned so that the snap-on sealing ring 40 is at least slightly widened by the protrusion 22 when the conical circumferential sealing surface 46 begins to overlap the axially extending extension 62.

FIG. 13A through, FIG. 13C depict an undesirable tooth-on-tooth condition, while FIG. 13D through FIG. 13F depict correct toothing engagement; each column shows oversized dimensions (left), mid-tolerance (center), and undersized dimensions (right); regardless of tolerance condition in the upper row, the detent does not engage, the catch lug 41a does not pass the protrusion 22, and the pre-assembly position is not reached, which can be recognized in that the snap-on sealing ring 40 does not latch and the components can be separated without substantial resistance.

In FIG. 13D through FIG. 13F, latching engagement is achieved; the teeth of the crown gearing system engage over at least a portion of their height and can therefore be clamped correctly; sealing contact between the snap-on sealing ring 40 and the axially extending extension 62 is maintained across tolerance conditions because tolerance compensation occurs at the axially extending extension 62, ensuring sealing after loading.

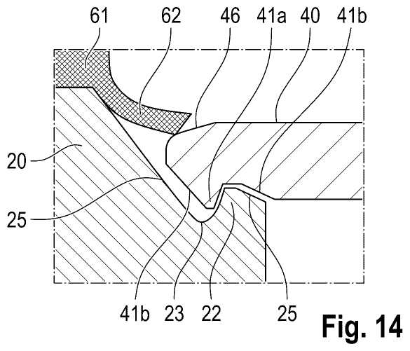

In FIG. 13D through FIG. 13F, a radially outer section of the axially extending extension 62 engages the conical circumferential sealing surface 46; this principle can be inverted as indicated in FIG. 14 (showing the detent mechanism at the pre-assembly position), where the conical circumferential sealing surface 46 is located radially on the outside at the snap-on sealing ring 40 to form sealing engagement with a radially inner section of the axially extending extension 62.

To support sealing engagement, an inclined section 25 can be provided on the second component 20; a chamfer or conical sliding surface 41b at the catch lug 41a can cooperate with the inclined section 25 during loading so that the end of the snap-on sealing ring 40 is widened and urged into engagement-initially or to a greater degree-with the axially extending extension 62; the inclined section 25 can be located at the protrusion 22 or elsewhere.

The examples and modifications described herein illustrate representative configurations; individual technical features disclosed in connection with specific features can be implemented independently of those features and/or in combination with other features, where technically feasible.

Accordingly, the present disclosure is not limited to the examples described herein and encompasses other configurations within the scope of the appended claims.

### LIST OF REFERENCE SIGNS

10 first component
11 first crown gear
12 thread opening
20 second component
21 second crown gear
22 protrusion
23 recess
24 sealing surface
25 inclined section
30 clamping device
40 snap-on sealing ring
41 detent mechanism
41a catch lug
41b conical sliding surface at the catch lug 41a
42 inner circumferential surface
43 outer circumferential surface
44 section
45 slit
46 sealing surface
50 elastic sealing element
51 leg
52 leg
53 sealing plate
54 trough
55 sealing lip
56 sealing lip
56a first leg
56b second leg
57 ring section
58 sealing lip
58a first section
58b second section
58c oblique bearing surface
58d first sealing lip
58e second sealing lip
60 wheel bearing seal
61 sealing element of the wheel bearing seal
62 axially extending extension
63 air gap
70 sealing element
150 wheel bearing
151 inner ring as a separate component
152 outer ring
153 rolling element ring
A cone angle
h tooth height
x axial play
A axis

1. An axially loaded crown gearing system, comprising:
a first component comprising a first crown gear;
a second component comprising a second crown gear;
the first crown gear and the second crown gear being in toothing engagement with one another and axially loaded with respect to one another; and
a snap-on sealing ring that surrounds the first and second crown gears radially on an outside and provides sealing,
wherein the snap-on sealing ring is fixed to one of the first and second components and comprises at least one catch lug configured to engage a recess of the other of the first and second components after passing a protrusion,
and wherein the snap-on sealing ring comprises, at an axial end face, a circumferential sealing surface configured to provide sealing with respect to an elastic sealing element that is axially less rigid than the snap-on sealing ring when an axially zero-backlash assembly position of the first and second crown gears has been reached.

2. The system of claim 1, wherein an axial rigidity of the snap-on sealing ring and of the elastic sealing element is selected to compensate a dimensional tolerance of 1 to 2 mm between relevant sealing surfaces while maintaining sealing performance.

3. The system of claim 1, wherein the elastic sealing element comprises an elastomer of Shore A hardness 20 to 60.

4. The system of claim 3, wherein the elastomer is of Shore A hardness 35 to 50.

5. The system of claim 1, wherein the elastic sealing element is integrally formed on a sealing element of a wheel bearing seal and comprises a lower Shore A hardness than the sealing element of the wheel bearing seal.

6. The system of claim 1, wherein the elastic sealing element comprises two legs joined to and angled with respect to one another such that, in a clamped state, both legs bear against the snap-on sealing ring to provide two sealing points.

7. The system of claim 1, wherein the elastic sealing element comprises a sealing plate comprising a sealing lip comprising at least one circumferential trough, and the snap-on sealing ring is pushed with the circumferential sealing surface into the trough.

8. The system of claim 7, wherein the circumferential sealing surface comprises a rounded region adapted to a contour of the trough.

9. The system of claim 1, wherein the elastic sealing element comprises a sealing plate comprising a sealing lip having an omega-shaped cross-section, and the snap-on sealing ring is pushed with the circumferential sealing surface against an apex of the omega shape.

10. The system of claim 1, wherein the elastic sealing element comprises a ring section configured to axially bear against the second component, and comprises one or more circumferential sealing lips that protrude toward the snap-on sealing ring and contact the snap-on sealing ring in sealing engagement, the one or more sealing lips defining, in cross-section, a positive or negative angle of 20° to 70° with the ring section at a region of contact with the snap-on sealing ring.

11. The system of claim 1, wherein in an unclamped state the snap-on sealing ring acts as a retaining clip that holds the first and second crown gears loosely in engagement such that an axial play is smaller than a tooth height of the first and second crown gears.

12. The system of claim 1, wherein, after the catch lug passes the protrusion, an overlap of the first and second crown gear teeth is 30% to 90% of the tooth height.

13. An axially loaded crown gearing system, comprising:
a first component comprising a first crown gear;
a second component comprising a second crown gear;
the first crown gear and the second crown gear being in toothing engagement with one another and axially loaded with respect to one another; and
a snap-on sealing ring that surrounds the first and second crown gears radially on an outside, the snap-on sealing ring being fixed to one of the first and second components and comprising at least one catch lug configured to engage a recess of the other of the first and second components after passing a protrusion,
wherein the snap-on sealing ring comprises, at an axial end face, a circumferential sealing surface configured to provide sealing with respect to a sealing element formed as a circumferential axially extending extension of a wheel bearing seal when an axially zero-backlash assembly position of the first and second crown gears has been reached.

14. The system of claim 13, wherein the axially extending extension comprises a cone angle of 5° to 50°.

15. The system of claim 14, wherein the cone angle is 5° to 25°.

16. The system of claim 13, wherein the circumferential sealing surface is conical and is positioned axially upstream of the catch lug, and a conical sliding surface at the catch lug is steeper than the conical circumferential sealing surface and is located radially inward of the conical circumferential sealing surface.

17. The system of claim 13, wherein the snap-on sealing ring is radially less rigid than the axially extending extension such that, under axial loading, the snap-on sealing ring elastically widens in a region of engagement with the axially extending extension and is pushed farther axially onto the axially extending extension to compensate dimensional deviations.

18. The system of claim 13, wherein in an unloaded state the axially extending extension is spaced from the second component by an air gap.

19. The system of claim 13, wherein a bearing surface at the second component comprises a conical support surface, and a cone angle of the seal at the axially extending extension is slightly smaller than a cone angle of the conical support surface to facilitate assembly.

20. A method of assembling an axially loaded crown gearing system, comprising:
engaging a first crown gear of a first component with a second crown gear of a second component such that axial play is smaller than a tooth height of the crown gears;
effecting a detenting engagement by a snap-on sealing ring fixed to one of the components and comprising at least one catch lug engaging a recess of the other component after passing a protrusion to establish a pre-assembly position; and
clamping the components together with a clamping device to achieve an axially zero-backlash assembly position while a circumferential sealing surface at an axial end face of the snap-on sealing ring provides sealing with respect to one of: (i) an elastic sealing element that is axially less rigid than the snap-on sealing ring; or (ii) a sealing element formed as a circumferential axially extending extension of a wheel bearing seal.
